(19) United States
(12) Patent Application Publication
(10) Pub. No.: US 2026/0051197 A1
(43) Pub. Date: Feb. 19, 2026

(54) BIOLOGICAL FEATURE EXTRACTION METHOD AND APPARATUS

(71) Applicant: CHINA UNIONPAY CO., LTD., Shanghai (CN)

(72) Inventors: Qi WANG, Shanghai (CN); Yanming YANG, Shanghai (CN); Pengfei GAO, Shanghai (CN); Yongkai ZHOU, Shanghai (CN); Gaolei ZHANG, Shanghai (CN); Xiaochao SUN, Shanghai (CN); Dong ZHAO, Shanghai (CN); Zhiqiang YOU, Shanghai (CN); Raobo ZHANG, Shanghai (CN)

(21) Appl. No.: 19/101,811

(22) PCT Filed: Nov. 30, 2022
(86) PCT No.: PCT/CN2022/135416

§ 371 Date: Feb. 6, 2025

(30) Foreign Application Priority Data
Aug. 16, 2022 (CN) 202210978590.X

(51) Int. Cl. G06V 40/16; G06N 3/048; G06T 5/20

(52) U.S. Cl. CPC G06V 40/168; G06N 3/048; G06T 5/20

(57) ABSTRACT

The embodiments of the present application relate to the technical field of artificial intelligence. Provided are a biological feature extraction method and apparatus. Fragmentation processing is performed on a biological feature extraction model to obtain a plurality of feature extraction model fragments, and the plurality of feature extraction model fragments are respectively deployed in different nodes, thereby ensuring that model parameters are not leaked. Moreover, fragmentation processing is performed on target biological information to obtain a plurality of biological information fragments; then, the plurality of biological information fragments are distributed to different nodes; and each node jointly performs feature extraction on the biological information fragments on the basis of its own locally deployed feature extraction model fragment and the feature extraction model fragments deployed in the other nodes, so as to obtain a biological feature vector fragment, such that the problem of a whole biological feature vector being obtained by means of calculation by a single device and being stored in a single environment is solved, thereby improving the security of biological feature extraction. In addition, the present application provides a universal calculation solution, which is applicable to various scenarios and has strong universality.

### CROSS-REFERENCE TO RELATED APPLICATION

This application claims priority to Chinese Patent Application No. 202210978590.X entitled “BIOLOGICAL FEATURE EXTRACTION METHOD AND APPARATUS,” filed on Aug. 16, 2022, the entire content of which is incorporated herein by reference.

### FIELD OF THE DISCLOSURE

The disclosure generally relates to the field of artificial intelligence technology and, more particularly, relates to a biometric feature extraction method and apparatus.

### BACKGROUND

In a biometric information recognition scenario (such as a face recognition scenario), a terminal obtains the registered biometric feature information, then extracts the features of the registered biometric feature information to obtain a biometric feature vector, and then saves the biometric feature vector and the corresponding registered identity information in the database. During the recognition and comparison, the terminal collects the to-be-identified biometric feature data and extracts the corresponding to-be-identified biometric feature vector. The to-be-identified biometric feature vector is then compared with each stored biometric feature vector to obtain the registered identity information corresponding to the matching biometric feature vector.

However, in the above solution, the biometric feature vector is calculated by a single device and stored in a single environment, which poses a risk of biometric feature vector leakage, thereby affecting data security.

### SUMMARY

The embodiments of the disclosure provide a method and apparatus for extracting biometric features to avoid leakage of biometric feature vectors and improve data security.

In one aspect, embodiments of the disclosure provide a biometric feature extraction method, which is applied to a node in a multi-party secure computing system, and the method includes: receiving a biometric information fragment sent by a terminal device, where the biometric information fragment is obtained after performing fragmentation processing on obtained target biometric information by the terminal device; and performing joint feature extraction processing on the biometric information fragment through a locally deployed first feature extraction model fragment and a second feature extraction model fragment deployed in at least one other node, to obtain a corresponding biometric feature vector shard, where the first feature extraction model fragment and at least one second feature extraction model fragment are obtained by performing fragmentation processing on a biometric feature extraction model.

In some embodiments, the first feature extraction model fragment includes a first convolution module, a first activation module, a first pooling module and a first fully connected module; and
performing joint feature extraction processing on the biometric information fragment through the locally deployed first feature extraction model fragment and the second feature extraction model fragment deployed in the at least one other node to obtain the corresponding biometric feature vector shard includes: obtaining, through the first convolution module, a first convolutional feature fragment corresponding to the biometric information fragment, combining the first activation module, the first pooling module, and a second activation module and a second pooling module in the at least one second feature extraction model fragment to perform activation processing and pooling processing on the first convolutional feature fragment to obtain a first pooling processing result; and performing fragmentation processing on the first pooling processing result to obtain a plurality of pooled feature fragments, and processing, through the first fully connected module, a first pooled feature fragment to obtain the biometric feature vector shard, where the first pooled feature fragment is determined based on undistributed pooled feature fragments among the plurality of pooled feature fragments and received pooled feature fragments distributed by other nodes.

In some embodiments, the first feature extraction model fragment further includes a first interaction module; and after performing fragmentation processing on the first pooling processing result to obtain the plurality of pooled feature fragments, the method further includes: distributing, through the first interaction module, at least one pooled feature fragment among the plurality of pooled feature fragments to the at least one other node accordingly.

In some embodiments, the first feature extraction model fragment further includes a first random mask module; and combining the first activation module, the first pooling module, and the second activation module and the second pooling module in the at least one second feature extraction model fragment to perform activation processing and pooling processing on the first convolutional feature fragment to obtain the first pooling processing result includes: performing, through the first random mask model, mask recovery processing on the first convolutional feature fragment based on a second convolutional feature fragment input into at least one second activation module, to obtain a first convolutional feature recovery result, performing, through the first activation module, activation processing on the first convolutional feature recovery result to obtain a first activation processing result, and performing fragmentation processing on the first activation processing result to obtain a plurality of activated feature fragments, performing, through the first random mask module, mask recovery processing on a first activated feature fragment based on a second activated feature fragment input into at least one second pooling module, to obtain a first activated feature recovery result, where the first activated feature fragment is determined based on undistributed activated feature fragments among the plurality of activated feature fragments and activated feature fragments distributed by the other nodes, and performing, through the first pooling module, pooling processing on the first activated feature recovery result to obtain the first pooling processing result.

In some embodiments, the first feature extraction model fragment further includes a first interaction module; and after performing fragmentation processing on the first activation processing result to obtain the plurality of activated feature fragments, the method further includes: distributing, through the first interaction module, at least one activated feature fragment, among the plurality of activated feature fragments, to the at least one other node accordingly.

In some embodiments, performing, through the first random mask module, mask recovery processing on the first convolutional feature fragment based on the second convolutional feature fragment input into the at least one second pooling module, to obtain the first convolutional feature recovery result includes: obtaining, through the first interaction module, partial feature values in each second convolutional feature fragment; and performing, through the first random mask module, mask recovery processing on the first convolutional feature fragment based on the obtained partial feature values to obtain the first convolutional feature recovery result, where the first convolutional feature recovery result is complementary to a second convolutional feature recovery result obtained by the at least one second feature extraction model fragment.

In some embodiments, performing, through the first random mask module, mask recovery processing on the first activated feature fragment among the plurality of activated feature fragments based on the second activated feature fragment input into the at least one second pooling module, to obtain the first activated feature recovery result includes: obtaining, through the first interaction module, partial feature values in each second activated feature fragment; and performing mask recovery processing on the first activated feature fragment based on the obtained partial feature values to obtain the first activated feature recovery result, where the first activated feature recovery result is complementary to a second activated feature recovery result obtained by the at least one second feature extraction model fragment.

In some embodiments, the second feature extraction model fragment includes a second convolution module; and obtaining, through the first convolution module, the first convolutional feature fragment corresponding to the biometric information fragment includes: performing joint convolution processing on the biometric information fragment through a fragmented convolution kernel in the first convolution module and a fragmented convolution kernel in at least one second convolution module, to obtain the first convolutional feature fragment.

In some embodiments, the second feature extraction model fragment includes a second convolution module; and obtaining, through the first convolution module, the first convolutional feature fragment corresponding to the biometric information fragment includes: performing convolution processing on the biometric information fragment through a plaintext convolution kernel in the first convolution module to obtain the first convolutional feature fragment, where the plaintext convolution kernel in the first convolution module is the same as a plaintext convolution kernel in a second convolution module.

In another aspect, embodiments of the disclosure provide a biometric feature extraction apparatus, which is applied to each node in a multi-party secure computing system, including: a receiving unit, configured to receive a biometric information fragment sent by a terminal device, where the biometric information fragment is obtained after performing fragmentation processing on obtained target biometric information by the terminal device; and a processing unit, configured to perform joint feature extraction processing on the biometric information fragment through a locally deployed first feature extraction model fragment and a second feature extraction model fragment deployed in at least one other node, to obtain a corresponding biometric feature vector shard, where the first feature extraction model fragment and at least one second feature extraction model fragment are obtained by performing fragmentation processing on a biometric feature extraction model

In some embodiments, the first feature extraction model fragment includes a first convolution module, a first activation module, a first pooling module and a first fully connected module.

The processing unit is specifically configured to: obtain, through the first convolution module, a first convolutional feature fragment corresponding to the biometric information fragment; combine the first activation module, the first pooling module, and a second activation module and a second pooling module in the at least one second feature extraction model fragment to perform activation processing and pooling processing on the first convolutional feature fragment to obtain a first pooling processing result; and performing fragmentation processing on the first pooling processing result to obtain a plurality of pooled feature fragments; and process, through the first fully connected module, a first pooled feature fragment to obtain the biometric feature vector shard, where the first pooled feature fragment is determined based on undistributed pooled feature fragments among the plurality of pooled feature fragments and received pooled feature fragments distributed by other nodes.

In some embodiments, the apparatus further includes a transmission unit, and the first feature extraction model fragment further includes a first interaction module; and the transmission unit 1203 is specifically configured to: after performing fragmentation processing on the first pooling processing result to obtain the plurality of pooled feature fragments, distribute, through the first interaction module, at least one pooled feature fragment among the plurality of pooled feature fragments to the at least one other node accordingly.

In some embodiments, the first feature extraction model fragment further includes a first random mask module; and the processing unit is specifically configured to: perform, through the first random mask model, mask recovery processing on the first convolutional feature fragment based on a second convolutional feature fragment input into at least one second activation module, to obtain a first convolutional feature recovery result; perform, through the first activation module, activation processing on the first convolutional feature recovery result to obtain a first activation processing result, and performing fragmentation processing on the first activation processing result to obtain a plurality of activated feature fragments; perform, through the first random mask module, mask recovery processing on a first activated feature fragment based on a second activated feature fragment input into at least one second pooling module, to obtain a first activated feature recovery result, where the first activated feature fragment is determined based on undistributed activated feature fragments among the plurality of activated feature fragments and activated feature fragments distributed by the other nodes; and perform, through the first pooling module, pooling processing on the first activated feature recovery result to obtain the first pooling processing result.

In some embodiments, the apparatus further includes a transmission unit, the first feature extraction model fragment further includes a first interaction module; and the transmission unit 1203 is specifically configured to: after performing fragmentation processing on the first activation processing result to obtain the plurality of activated feature fragments, distribute, through the first interaction module, at least one activated feature fragment, among the plurality of activated feature fragments, to the at least one other node accordingly.

In some embodiments, the processing unit is specifically configured to: obtain, through the first interaction module, partial feature values in each second convolutional feature fragment; and perform, through the first random mask module, mask recovery processing on the first convolutional feature fragment based on the obtained partial feature values to obtain the first convolutional feature recovery result, where the first convolutional feature recovery result is complementary to a second convolutional feature recovery result obtained by the at least one second feature extraction model fragment.

In some embodiments, the processing unit is specifically configured to: obtain, through the first interaction module, partial feature values in each second activated feature fragment; and perform mask recovery processing on the first activated feature fragment based on the obtained partial feature values to obtain the first activated feature recovery result, where the first activated feature recovery result is complementary to a second activated feature recovery result obtained by the at least one second feature extraction model fragment.

In some embodiments, the second feature extraction model fragment includes a second convolution module; and the processing unit is specifically configured to: perform joint convolution processing on the biometric information fragment through a fragmented convolution kernel in the first convolution module and a fragmented convolution kernel in at least one second convolution module, to obtain the first convolutional feature fragment.

In some embodiments, the second feature extraction model fragment includes a second convolution module; and the processing unit is specifically configured to: perform convolution processing on the biometric information fragment through a plaintext convolution kernel in the first convolution module to obtain the first convolutional feature fragment, where the plaintext convolution kernel in the first convolution module is the same as a plaintext convolution kernel in a second convolution module.

In another aspect, embodiments of the disclosure provide a computer device, including a memory, a processor, and a computer program stored in the memory and executable on the processor, where the processor implements the steps of the above-described biometric feature extraction method when executing the program.

In another aspect, embodiments of the disclosure provide a computer-readable storage medium, which stores a computer program that may be executed by a computer device. When the program is run on the computer device, the computer device executes the steps of the above-described biometric feature extraction method.

In another aspect, embodiments of the disclosure provide a computer program product, which includes a computer program stored on a computer-readable storage medium, and the computer program includes program instructions. When the program instructions are executed by a computer device, the computer device executes the steps of the above-described biometric extraction method.

In the embodiments of the disclosure, a biometric feature extraction model is fragmented to obtain a plurality of feature extraction model fragments, and the plurality of feature extraction model fragments are respectively deployed in different nodes, thereby ensuring that the model parameters are not leaked. When extracting features from target biometric information, the target biometric information is first fragmented to obtain a plurality of biometric information fragments, and then the plurality of biometric information fragments are distributed to different nodes. Each node extracts features from the biometric information fragment based on a locally deployed feature extraction model fragment and a feature extraction model fragment deployed by another node to obtain a biometric feature vector shard, so that each node needs to be combined with the other node(s) to extract biometric features, and each node obtains just part of the biometric feature vector, avoiding the problem that the entire biometric feature vector is calculated by a single device and stored in a single environment, thereby improving the security of biometric feature extraction. In addition, the embodiments of the disclosure provide a general computing solution that may be applied to many types of feature extraction models and scenarios, and has strong versatility.

### BRIEF DESCRIPTION OF THE DRAWINGS

In order to more clearly illustrate the technical solutions in the embodiments of the disclosure, the drawings essential for understanding the description of the embodiments will be briefly introduced below. Obviously, the drawings described below are merely some embodiments of the disclosure. For a person skilled in the art, other drawings may be obtained based on these drawings without making creative efforts.

FIG. 1 is a schematic diagram of a system architecture, according to some embodiments of the disclosure;

FIG. 2 is a flowchart of a method of extracting biometric features, according to some embodiments of the disclosure;

FIG. 3 is a flowchart of a data preprocessing method, according to some embodiments of the disclosure;

FIG. 4 is a flowchart of a model parameter fragmentation processing method, according to some embodiments of the disclosure;

FIG. 5 is a schematic structural diagram of a multi-party secure computing system, according to some embodiments of the disclosure;

FIG. 6 is a flowchart of a method for extracting biometric features, according to some embodiments of the disclosure;

FIG. 7 is a flowchart of a convolution processing method, according to some embodiments of the disclosure;

FIG. 8 is a flowchart of another convolution processing method, according to some embodiments of the disclosure;

FIG. 9 is a flowchart of an activation processing method, according to some embodiments of the disclosure;

FIG. 10 is a flowchart of a pooling treatment method, according to some embodiments of the disclosure;

FIG. 11 is a flowchart of another method for extracting biometric features, according to some embodiments of the disclosure;

FIG. 12 is a schematic structural diagram of a biometric feature extraction apparatus, according to some embodiments of the disclosure; and

FIG. 13 is a schematic structural diagram of a computer device, according to some embodiments of the disclosure.

### DETAILED DESCRIPTION

In order to make the purposes, technical solutions and beneficial effects of the disclosure more clearly understood, the disclosure is further described in detail below in conjunction with the accompanying drawings and specific embodiments. It should be understood that the specific embodiments described herein are merely used to explain the present disclosure and are not intended to limit the disclosure.

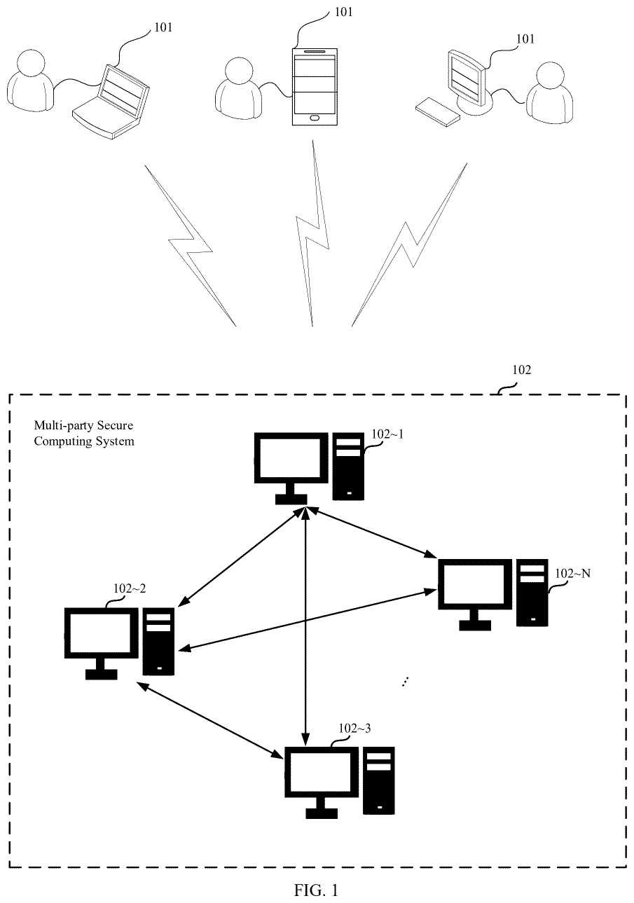

FIG. 1 is a schematic diagram of a system architecture, according to some embodiments of the disclosure. The system architecture includes a terminal device 101 and a multi-party secure computing system 102, where the multi-party secure computing system 102 includes a plurality of nodes, and the plurality of nodes include node 102˜1, node 102˜2, . . . , node 102˜N, where N is an integer greater than 0.

The terminal device 101 is pre-installed with a target application that requires biometric information recognition, such as a payment application, an instant messaging application, a video application, a shopping application, etc. Each terminal device has the function of collecting biometric information, where the biometric information includes but is not limited to face information, fingerprint information, and iris information. The terminal device 101 may be a smart phone, a tablet, a laptop, a desktop computer, a smart home appliance, a smart voice interaction device, a smart car device, etc., but is not limited thereto.

At least one of the plurality of nodes is the backend server of the target application, and the other nodes are nodes that cooperate to extract biometric features and identify biometric information. A node may be an independent physical server, or a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks (CDN), and big data and artificial intelligence platforms, etc. The terminal device and a corresponding node may be directly or indirectly connected by wired or wireless communication, and any two nodes may be directly or indirectly connected by wired or wireless communication, which is not limited in the disclosure.

In practical applications, the biometric feature extraction methods in the embodiments of the disclosure may be applied to payment scenarios, login scenarios, identity authentication scenarios, etc.

It is to be noted that in the specific implementation of the disclosure, biometric information data such as facial information, fingerprint information, iris information, etc., is involved. When the embodiments in the disclosure are applied to specific products or technologies, user permission or consent is required, and the collection, use and processing of relevant data must comply with relevant laws, regulations and standards of the involved countries and regions.

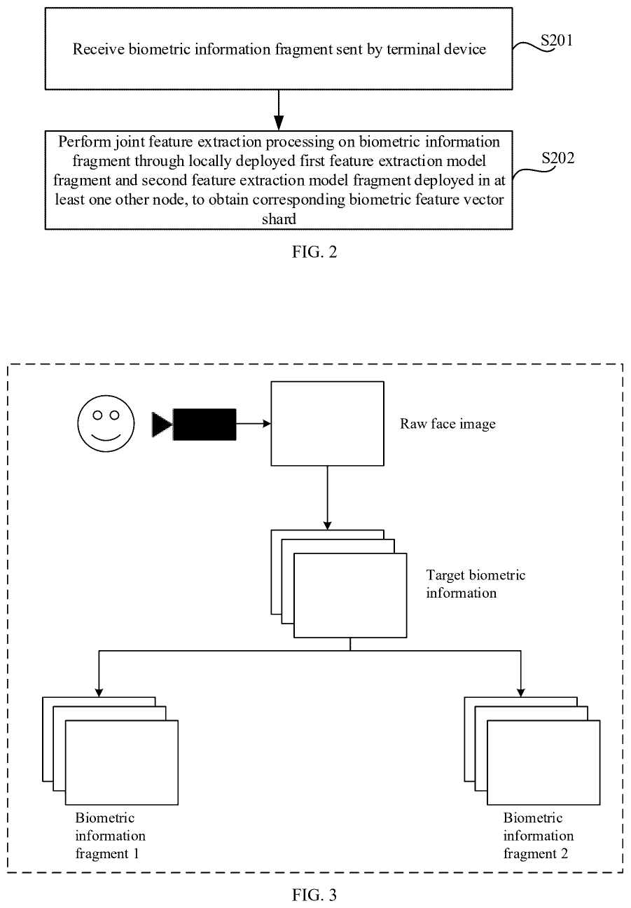

Based on the system architecture diagram shown in FIG. 1, the embodiments of the disclosure provide a flowchart of a method of extracting biometric features, as shown in FIG. 2. The method is executed by a computer device, which may be a node shown in FIG. 1, and includes the following steps.

Step S201: Receive a biometric information fragment sent by a terminal device.

Specifically, the biometric information fragment is obtained after the terminal device performs fragmentation processing on obtained target biometric information. The target biometric information includes but is not limited to face images, fingerprint images, and iris images. The target biometric information corresponds to a biometric identity, which may be a name, a unique number such as a user ID, etc. Accordingly, after the target biometric information is fragmented, each biometric information fragment obtained also corresponds to the biometric identity.

In some embodiments, after collecting the original biometric information, the terminal device pre-processes the original biometric information to obtain the target biometric information. Specifically, after normalizing the original biometric information, the original biometric information is converted into a three-dimensional matrix to obtain the target biometric information.

Taking the original biometric information as a raw face image as an example, as shown in FIG. 3, after the terminal device collects the raw face image, pixel values of the raw face image are first normalized to floating-point numbers between 0 and 1. Next, the size of the raw face image is adjusted to (224, 224). After that, the raw face image is converted into a three-dimensional matrix to obtain the target biometric information.

Define a random three-dimensional matrix with the same size as the target biometric information as biometric information fragment 1, and subtract the three-dimensional matrix corresponding to the target biometric information from the biometric information fragment 1, to obtain biometric information fragment 2. Both biometric information fragment 1 and biometric information fragment 2 are three-dimensional matrices.

It should be noted that the embodiments of the disclosure are not limited to fragmenting the target biometric information into two biometric information fragments, and the target biometric information may also be fragmented into other numbers (3, 4, etc.) of biometric information fragments, which is not specifically limited in the disclosure.

Step S202: Perform joint feature extraction processing on the biometric information fragment through a locally deployed first feature extraction model fragment and a second feature extraction model fragment deployed in at least one other node, to obtain a corresponding biometric feature vector shard.

Specifically, the first feature extraction model fragment and at least one second feature extraction model fragment are obtained by performing fragmentation processing on a biometric extraction model, where the biometric extraction model may be pre-trained by a node in the multi-party secure computing system, or pre-trained by a terminal device or other devices.

The training process of the biometric feature extraction model is as follows.

Sample preparation stage: First, collect the raw face image set for model training, and normalize the pixel values of each raw face image to floating-point numbers between 0 and 1. This operation facilitates the convergence of model training. Then perform data augmentation processing on the raw face image set, such as random horizontal flipping, shear transformation, etc. This operation facilitates improving the generalization ability of the training model. After that, resize each raw face image to (224, 224) to obtain a sample image set.

Model training phase: The biometric feature extraction model under the training is trained by iterative stochastic gradient descent with a small batch of sample images, where the learning rate is 0.1, the momentum is 0.9, and the loss function is a multi-category cross-loss function. In each iteration, a small batch of sample images are selected from the sample image set, and then the small batch of sample images are shuffled and input into the biometric feature extraction model under the training. The biometric feature extraction model under the training processes the small batch of sample images to obtain feature extraction results. Then, based on the feature extraction results and the loss function, the loss value of the current iteration process is determined. The loss value is used to adjust the parameters of the biometric feature extraction model under the training, and after the parameters are adjusted, the next iteration begins. When the loss value meets a preset convergence condition, or the number of iterative training reaches a preset threshold, the training process ends, and a trained biometric feature extraction model is obtained. The trained biometric feature extraction model corresponds to a model file, which is saved in the “xxx.h5” format, and the file content includes the entire structure of the model and the weight parameter values of each layer of the model.

In practical applications, fragmentation of the biometric feature extraction model actually refers to the fragmentation of the model parameters of the biometric feature extraction model, which may be represented by a multi-dimensional matrix. The model parameters of the biometric feature extraction model are fragmented to obtain a plurality of model parameter shard files, and then each model parameter shard file is distributed to a node. The node saves the model parameter shard file and deploys the corresponding feature extraction model fragment based on the model parameter shard file. After the node obtains the biometric information fragment, the model parameter loader in the node reads the locally saved model parameter shard file, and then loads the model parameter fragment in the model parameter shard file into the model runtime.

The model runtime performs local operations and interacts with other nodes to jointly extract features from the biometric information fragment to obtain the corresponding biometric feature vector shard.

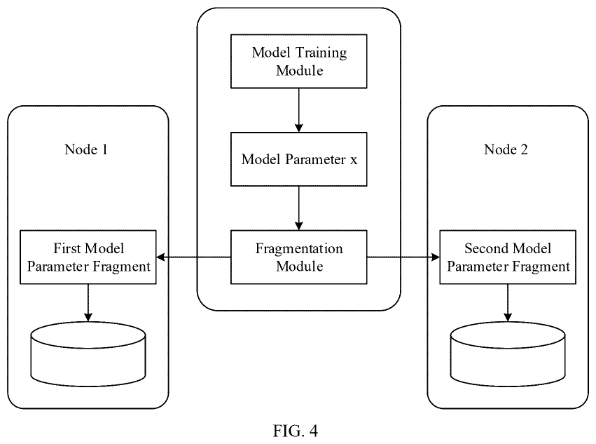

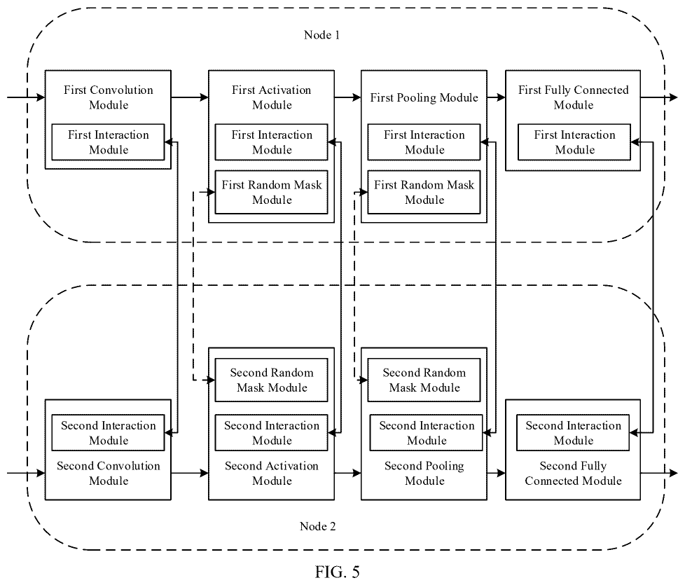

For example, as shown in FIG. 4, the device configured for model training includes a model training module and a fragmentation module. After training the obtained biometric feature extraction model, the model training module obtains model parameter x, which is represented by a multidimensional matrix. The model parameter x is fragmented

$${Shr}_{A}^{i} ( x )$$

by the fragmentation module to obtain

$${〈 x 〉}_{A}^{0} and {〈 x 〉}_{A}^{1} ,$$

where A represents an arithmetic fragmentation type, that is, real number values, and i represents the index number of the fragment.

$${Shr}_{A}^{i} ( x )$$

represents the arithmetic type fragmentation of the model parameter x,

$${〈 x 〉}_{A}^{0}$$

represents the first model parameter fragment, and

$${〈 x 〉}_{A}^{1}$$

represents the second model parameter fragment.

$${〈 x 〉}_{A}^{0} , {〈 x 〉}_{A}^{1}$$

and x are multidimensional matrices of the same size (shape), and

$${〈 x 〉}_{A}^{0} and {〈 x 〉}_{A}^{1}$$

are added together to obtain the model parameter x. In the fragmentation process,

$${〈 x 〉}_{A}^{0}$$

is generated by random numbers, and then subtracted from the model parameter x to obtain

$${〈 x 〉}_{A}^{1} .$$

In order to ensure that the model parameter fragments are within the range of the data type, the model parameter fragments are usually modulo calculated to satisfy the following Formula (1):

$${〈 x 〉}_{A}^{0} + {〈 x 〉}_{A}^{1} ≡ x ( mod {2}^{1} ) \qquad ( 1 )$$

where

$${〈 x 〉}_{A}^{0} , {〈 x 〉}_{A}^{1}$$

∈Z₂_{^{l}}, and Z₂_{^{l}} represent the range of real numbers of 2 to the power of 1.

After obtaining the first model parameter fragment and the second model parameter fragment, the first model parameter fragment is sent to node 1, and node 1 saves the first model parameter fragment in a MySQL database. The second model parameter fragment is sent to node 2, and node 2 saves the second model parameter fragment in a MySQL database.

In the embodiments of the disclosure, the biometric feature extraction model is fragmented to obtain a plurality of feature extraction model fragments, and the plurality of feature extraction model fragments are respectively deployed in different nodes, thereby ensuring that the model parameters are not easily leaked. When extracting features from the target biometric information, the target biometric information is first fragmented to obtain a plurality of biometric information fragments, and then the plurality of biometric information fragments are distributed to different nodes. Each node extracts features from a biometric information fragment based on a locally deployed feature extraction model fragment and a feature extraction model fragment deployed by another node to obtain a biometric feature vector shard, so that each node needs to be combined with another node to extract biometric features, and each node merely obtains part of the biometric feature vector, avoiding the problem that the entire biometric feature vector is calculated by a single device and stored in a single environment, thereby improving the security of biometric feature extraction. In addition, the embodiments of the disclosure provide a general computing solution that may be applied to many types of feature extraction models and scenarios, and has strong versatility.

In some embodiments, the first feature extraction model fragment includes a first convolution module, a first activation module, a first pooling module, and a first fully connected module. Additionally, a first interaction module may be added to each module in the first feature extraction model fragment, or the first interaction module may be added just to a module that needs to interact with other nodes, or a general first interaction module may be added to the first feature extraction model fragment. In addition, a first random mask module may be added to each module that uses mask technology for feature extraction, or a general first random mask module may be added to the first feature extraction model fragment, which is not specifically limited in the disclosure.

Correspondingly, the second feature extraction model fragment includes a second convolution module, a second activation module, a second pooling module and a second fully connected module. Additionally, a second interaction module may be added to each module in the second feature extraction model fragment, or a second interaction module may be added just to a module that needs to interact with other nodes, or a general second interaction module may be added to the second feature extraction model fragment. In addition, a second random mask module may be added to each module that uses mask technology for feature extraction, or a general second random mask module may be added to the second feature extraction model fragment, which is not specifically limited in the disclosure.

For example, as shown in FIG. 5, the multi-party secure computing system includes node 1 and node 2, where node 1 includes a first feature extraction model fragment, and the first feature extraction model fragment includes a first convolution module, a first activation module, a first pooling module and a first fully connected module. Each module includes a first interaction module, and the first activation module and the first pooling module also include a first random mask module.

Node 2 includes a second feature extraction model fragment, which includes a second convolution module, a second activation module, a second pooling module and a second fully connected module. Each module includes a second interaction module, and the second activation module and the second pooling module also include a second random mask module.

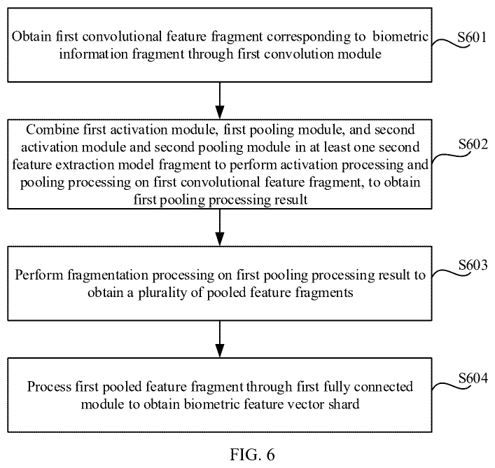

In some embodiments, the process of performing joint feature extraction processing on a biometric information fragment through a locally deployed first feature extraction model fragment and a second feature extraction model fragment deployed in at least one other node is shown in FIG. 6 and includes the following steps.

Step S601: Obtain a first convolutional feature fragment corresponding to a biometric information fragment through a first convolution module.

In some embodiments, after the biometric feature extraction model is fragmented, the plaintext convolution kernel in the biometric feature extraction model is fragmented into a plurality of fragmented convolution kernels, each of which is located in a convolution module. Therefore, when performing feature extraction, the biometric information fragment is jointly convolved by a fragmented convolution kernel in the first convolution module and a fragmented convolution kernel in at least one second convolution module to obtain the first convolutional feature fragment.

Specifically, the first convolution module and the second convolution module interact with each other through the first interaction module and the second interaction module to perform joint convolution processing to obtain the first convolutional feature fragment.

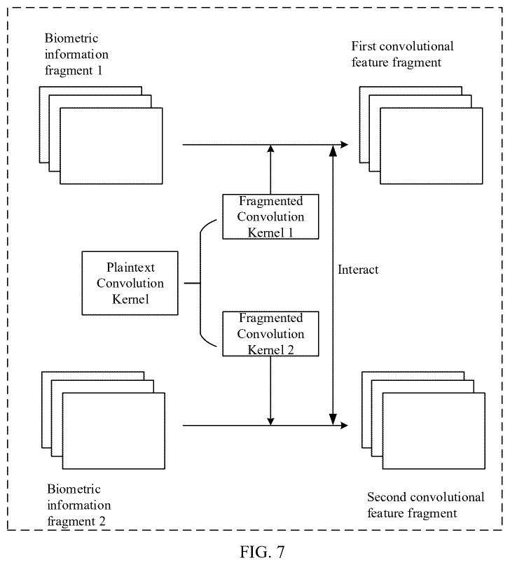

For example, as shown in FIG. 7, after the biometric extraction model is fragmented, the plaintext convolution kernel in the biometric extraction model is fragmented into fragmented convolution kernel 1 and fragmented convolution kernel 2, where the fragmented convolution kernel 1 is located in the first convolution module and the fragmented convolution kernel 2 is located in the second convolution module.

The biometric information fragment 1 is input into the first convolution module, the first convolution module interacts with the second convolution module, and the fragmented convolution kernel 1 and the fragmented convolution kernel 2 jointly perform convolution processing on the biometric information fragment 1 to obtain the first convolutional feature fragment.

The biometric information fragment 2 is input into the second convolution module, the second convolution module interacts with the first convolution module, and the fragmented convolution kernel 1 and the fragmented convolution kernel 2 jointly perform convolution processing on the biometric information fragment 2 to obtain the second convolutional feature fragment.

In some embodiments, both the first convolution module and the second convolution module include a plaintext convolution kernel in the biometric feature extraction model, that is, the plaintext convolution kernel in the first convolution module is the same as the plaintext convolution kernel in the second convolution module. Then, the biometric information fragment is convolved through the plaintext convolution kernel in the first convolution module, to obtain the first convolutional feature fragment.

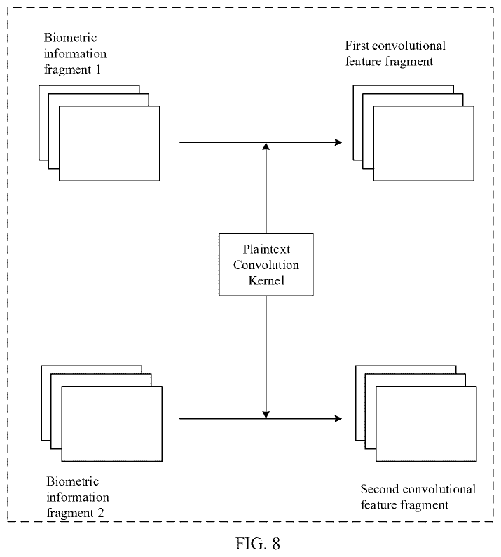

For example, as shown in FIG. 8, both the first convolution module and the second convolution module include a plaintext convolution kernel in the biometric feature extraction model. The biometric information fragment 1 is input into the first convolution module, and the first convolution module performs convolution processing on the biometric information fragment 1 through the plaintext convolution kernel to obtain the first convolutional feature fragment. The biometric information fragment 2 is input into the second convolution module, and the second convolution module performs convolution processing on the biometric information fragment 2 through the plaintext convolution kernel to obtain the second convolutional feature fragment.

Step S602: Combine the first activation module, the first pooling module, and a second activation module and a second pooling module in at least one second feature extraction model fragment to perform activation processing and pooling processing on the first convolutional feature fragment, to obtain a first pooling processing result.

Specifically, the first convolutional feature fragment is subjected to nonlinear activation processing through an activation function, where the activation function may be a Sigmoid function, a TanH function, a ReLU function, etc. Pooling processing includes average pooling processing, maximum pooling processing, and the like.

In some embodiments, through a first random mask module, mask recovery processing is performed on the first convolutional feature fragment based on a second convolutional feature fragment input into at least one second activation module to obtain a first convolutional feature recovery result.

Specifically, the second convolutional feature fragment is output by the second convolution module. Through the first interaction module, partial feature values in each second convolutional feature fragment are obtained, where the partial feature values in the second convolutional feature fragment are randomly selected from the second convolutional feature fragment. Then, through the first random mask module, mask recovery processing is performed on the first convolutional feature fragment based on the obtained partial feature values to obtain a first convolutional feature recovery result, where the first convolutional feature recovery result is complementary to a second convolutional feature recovery result obtained by at least one second feature extraction model fragment.

In a specific implementation, mask recovery processing is performed on the feature values at the corresponding positions of the first convolutional feature fragment using the obtained partial feature values to obtain the plaintext feature values (also referred to as recovered feature values) at the corresponding positions. The unrecovered features in the first convolutional feature fragment are represented by 0 and are regarded as masks. Other nodes also perform mask recovery processing to obtain a second convolutional feature recovery result. The positions of the plaintext feature values in the second convolutional feature recovery result are different from the positions of the plaintext feature values in the first convolutional feature recovery result, and the first convolutional feature recovery result is complementary to at least one second convolutional feature recovery result. That is, the first convolutional feature recovery result is combined with at least one second convolutional feature recovery result to obtain a plaintext convolution feature. The first convolutional feature recovery result is activated by the first activation module to obtain a first activation processing result, and the first activation processing result is fragmented to obtain a plurality of activated feature fragments.

In some embodiments, at least one activated feature fragment of the plurality of activated feature fragments is distributed to at least one other node through the first interaction module. Similarly, the activated feature fragment distributed by at least one other node is received through the first interaction module, and then the first activated feature fragment is determined based on the undistributed activated feature fragment(s) and the received activated feature fragment(s) distributed by at least one other node.

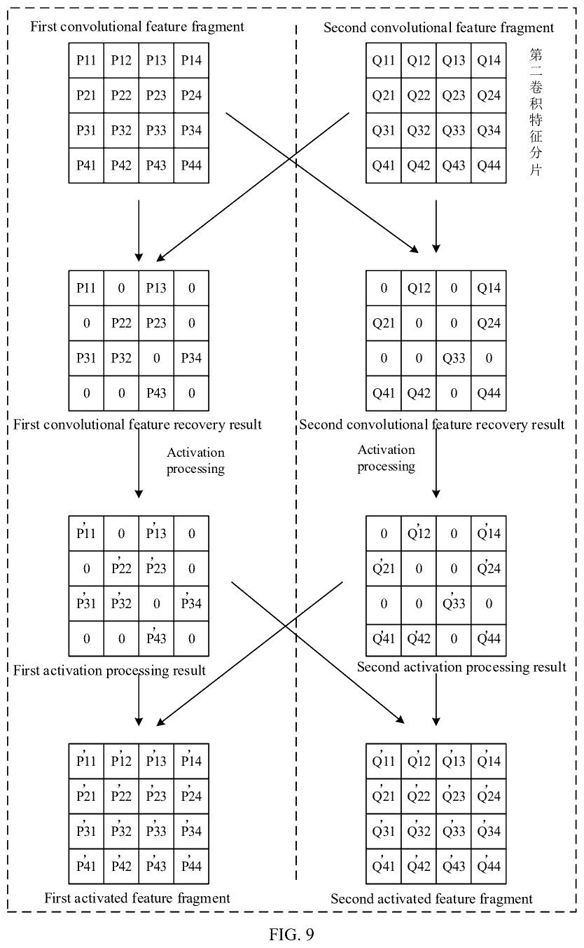

For example, as shown in FIG. 9, for node 1, the first convolution module outputs the first convolutional feature fragment to the first activation module, and the first activation module obtains, through the first interaction module, partial feature values in the second convolutional feature fragment from the second activation module. Through the first random mask module, the first convolutional feature fragment is masked and recovered based on the obtained partial feature values to obtain the first convolutional feature recovery result, where, in the 4×4 matrix corresponding to the first convolutional feature recovery result, the feature values of P₁₁, P₁₃, P₂₂, P₂₃, P₃₁, P₃₂, P₃₄, P₄₃ are the recovered feature values. The feature values of P₁₂, P₁₄, P₂₁, P₂₄, P₃₃, P₄₁, P₄₂, P₄₄ are all 0 and are regarded as masks, where P₁₁ represents the first row and first column in the matrix, which also applies to the others. Through the first activation module, the first convolutional feature recovery result is activated to obtain a first activation processing result, and the first activation processing result is fragmented to obtain two activated feature fragments, namely, activated feature fragment 1 and activated feature fragment 2, and activated feature fragment 2 is distributed to node 2.

For node 2, the second convolution module outputs the second convolutional feature fragment to the second activation module, and the second activation module obtains partial feature values in the first convolutional feature fragment from the first activation module through the second interaction module. Through the second random mask module, the second convolutional feature fragment is subjected to mask recovery operation based on the obtained partial feature values to obtain a second convolutional feature recovery result, where, in the 4×4 matrix corresponding to the second convolutional feature recovery result, the feature values of Q₁₁, Q₁₃, Q₂₂, Q₂₃, Q₃₁, Q₃₂, Q₃₄, Q₄₃ are all 0, which is regarded as a mask. The feature values of Q₁₂, Q₁₄, Q₂₁, Q₂₄, Q₃₃, Q₄₁, Q₄₂, Q₄₄ are the recovery feature values, where Q₁₁ represents the first row and first column in the matrix, which also applies to the others. The first convolutional feature recovery result and the second convolutional feature recovery result are strictly complementary.

The first convolutional feature recovery result is activated by the second activation module to obtain a second activation result, and the second activation result is fragmented to obtain two activated feature fragments, namely, activated feature fragment 3 and activated feature fragment 4. Activated feature fragment 4 is distributed to node 1.

Node 1 combines activated feature fragment 1 with received activated feature fragment 4 to obtain a first activated feature fragment, and inputs the first activated feature fragment into a first pooling module. Node 2 combines activated feature fragment 3 with received activated feature fragment 2 to obtain a second activated feature fragment, and inputs the second activated feature fragment into a second pooling module.

In the embodiments of the disclosure, a plaintext and ciphertext mixed operation is performed based on a mask in the activation module, which ensures that the activation module in each node may just restore partial feature values, avoids a single device from obtaining the whole feature vector, and thus improves the security of data during the feature extraction process.

In some embodiments, through the first random mask module, mask recovery processing is performed on the first activated feature fragment based on the second activated feature fragment input to at least one second pooling module to obtain a first activated feature recovery result. Then, a pooling process is performed on the first activated feature recovery result through the first pooling module to obtain a first pooling processing result.

Specifically, through the first interaction module, partial feature values in each second activated feature fragment are obtained. Through the first random mask module, mask recovery processing is performed on the first activated feature fragment based on the obtained partial feature values to obtain a first activated feature recovery result, where the first activated feature recovery result is complementary to a second activated feature recovery result obtained by at least one second feature extraction model fragment.

The obtained partial feature values are used to perform mask recovery processing on the feature values at the corresponding positions of the first activated feature fragment to obtain the plaintext feature values (also referred to as recovered feature values) at the corresponding positions. The unrecovered features in the first activated feature fragment are represented by 0 and regarded as a mask. Another node also performs mask recovery processing to obtain a second activated feature recovery result. The positions of the plaintext feature values in the second activated feature recovery result are different from the positions of the plaintext feature values in the first activated feature recovery result, and the first activated feature recovery result is complementary to at least one second activated feature recovery result. That is, the first activated feature recovery result is combined with at least one second activated feature recovery result to obtain the activated feature in the plaintext state. The first activated feature recovery result is also pooled by the first pooling module to obtain a first pooling processing result.

Step S603: Fragment the first pooling processing result to obtain a plurality of pooled feature fragments.

Distribute, through the first interaction module, at least one pooled feature fragment, of the plurality of pooled feature fragments, to at least one other node accordingly. Similarly, a pooled feature fragment distributed by at least one other node is received through the first interaction module, and then a first pooled feature fragment is determined based on the undistributed pooled feature fragment(s) and the received pooled feature fragment(s) distributed by the at least one other node.

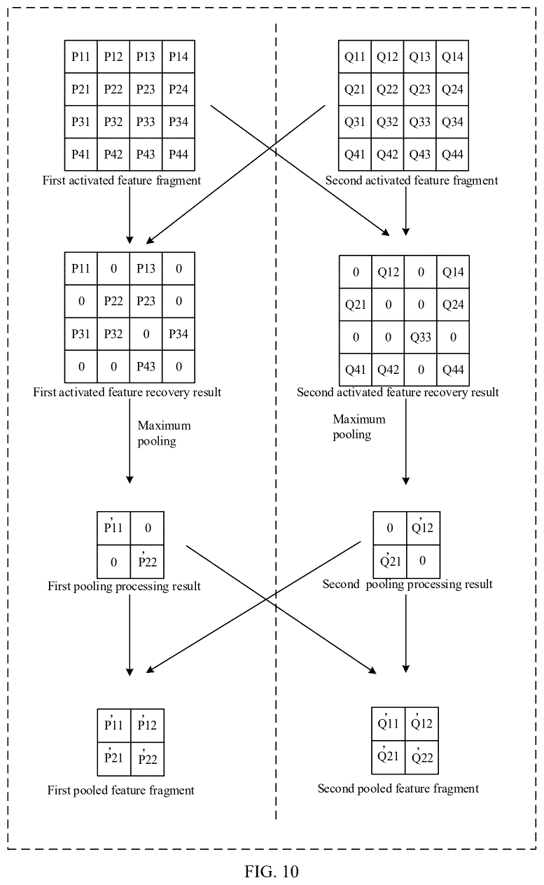

For example, as shown in FIG. 10, for node 1, the first pooling module obtains partial feature values in the second activated feature fragment from the second pooling module through the first interaction module. Through the first random mask module, the first activated feature fragment is subjected to mask recovery processing based on the obtained partial feature values to obtain a first activated feature recovery result. In the 4×4 matrix corresponding to the first activated feature recovery result, the feature values of P₁₁, P₁₃, P₂₂, P₂₃, P₃₁, P₃₂, P₃₄, P₄₃ are the recovered feature values. The feature values of P₁₂, P₁₄, P₂₁, P₂₄, P₃₃, P₄₁, P₄₂, P₄₄ are all 0 and are regarded as masks. The first pooling module performs maximum pooling processing on the first activated feature recovery result to obtain a first pooling processing result, and performs fragmentation processing on the first pooling processing result to obtain two pooled feature fragments, namely, pooled feature fragment 1 and pooled feature fragment 2. Pooled feature fragment 2 is distributed to node 2.

For node 2, through the second interaction module, the second pooling module obtains partial feature values in the first activated feature fragment from the first pooling module. Through the second random mask module, the second activated feature fragment is subjected to mask recovery operation based on the obtained partial feature values to obtain a second activated feature recovery result. In the 4×4 matrix corresponding to the second activated feature recovery result, the feature values of Q₁₁, Q₁₃, Q₂₂, Q₂₃, Q₃₁, Q₃₂, Q₃₄, Q₄₃ are all 0, which are regarded as masks. The feature values of Q₁₂, Q₁₄, Q₂₁, Q₂₄, Q₃₃, Q₄₁, Q₄₂, Q₄₄ are the recovered feature values. The second pooling module performs maximum pooling processing on the second activated feature recovery result to obtain a second pooling processing result, and performs fragmentation processing on the second pooling processing result to obtain two pooled feature fragments, namely, pooled feature fragment 3 and pooled feature fragment 4. Pooled feature fragment 4 is distributed to node 1.

Node 1 combines pooled feature fragment 1 with received pooled feature fragment 4 to obtain a first pooled feature fragment, and inputs the first pooled feature fragment into a first fully connected module. Node 2 combines pooled feature fragment 3 with received pooled feature fragment 2 to obtain a second pooled feature fragment, and inputs the second pooled feature fragment into a second fully connected module.

Step S604: Process the first pooled feature fragment through the first fully connected module to obtain a biometric feature vector shard.

Specifically, through the first fully connected module, a vector inner product operation is performed on the first pooled feature fragment based on weight parameters to obtain a biometric feature vector shard.

In some embodiments, a plaintext and ciphertext mixed operation is performed based on a mask in the pooling module, ensuring that the pooling module in each node may just recover partial feature values, avoiding a single device from obtaining the whole feature vector, thereby improving the security of data during the feature extraction process.

In some embodiments, after obtaining the biometric feature vector shard corresponding to the biometric information fragment, the biometric feature vector shard corresponding to the biometric information fragment is saved, and the biometric feature vector shard is used for biometric information identification.

Specifically, the terminal device collects the to-be-identified biometric information, and then fragments the to-be-identified biometric information to obtain a plurality of to-be-identified information fragments. The plurality of to-be-identified information fragments are sent to a plurality of nodes. Each node uses the biometric feature extraction method described above to obtain a to-be-identified feature vector shard corresponding to the to-be-identified information fragment.

In one possible implementation, each node calculates the similarity between the to-be-identified feature vector shard and each saved biometric feature vector shard, selects a biometric feature vector with the greatest similarity, and obtains the corresponding maximum similarity. One of the plurality of nodes aggregates the maximum similarities obtained by all nodes to obtain a target similarity. If the target similarity is greater than a preset threshold, the biometric information recognition result of the to-be-identified biometric information is determined to be a pass, otherwise, the biometric information recognition result of the to-be-identified biometric information is determined to be a fail. The biometric information recognition result is sent to the terminal device.

In another possible implementation, the to-be-identified feature vector shard corresponds to a biometric identity, and each node selects a corresponding target feature vector shard from a plurality of saved biometric feature vector shards based on the biometric identity. Then the fragment similarity between the to-be-identified feature vector shard and the target feature vector shard is calculated. One of the plurality of nodes aggregates the fragment similarities obtained by all nodes to obtain a target similarity. If the target similarity is greater than a preset threshold, the biometric information identification result of the to-be-identified biometric information is determined to be a pass, otherwise, the biometric information identification result of the to-be-identified biometric information is determined to be a fail. The biometric information identification result is then sent to the terminal device.

The biometric information recognition method described above may be applied to payment scenarios, login scenarios, verification scenarios, etc.

In the embodiments of the disclosure, a biometric feature extraction model is fragmented to obtain a plurality of feature extraction model fragments, and the plurality of feature extraction model fragments are respectively deployed in different nodes, thereby ensuring that the model parameters are not leaked. The biometric information fragments are feature extracted by a plurality of feature extraction model fragments to obtain biometric feature vector shards. Then, a plurality of biometric feature vector shards jointly perform biometric information recognition, thereby avoiding the use of a single device for feature extraction and biometric information recognition, thereby improving the security of biometric feature extraction.

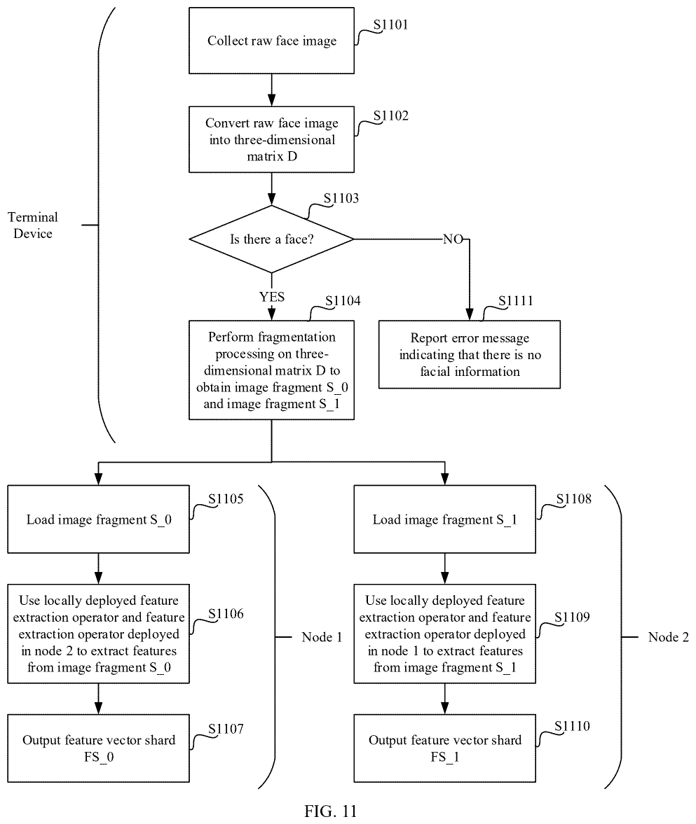

In order to better explain the disclosed embodiments, a biometric feature extraction method provided by the embodiments of the disclosure is further described below in combination with a specific implementation scenario. The process of the method may be executed by a terminal device and a multi-party secure computing system, where the multi-party secure computing system includes a node 1 and a node 2, and the method includes the following steps, as shown in FIG. 11.

Step S1101: The terminal device collects a raw face image.

Step S1102: The terminal device converts the raw face image into a three-dimensional matrix D.

Step S1103: Determine whether there is a face, if so, proceed to Step S1104, otherwise proceed to Step S1111.

Step S1104: The terminal device performs fragmentation processing on the three-dimensional matrix D to obtain an image fragment S_0 and an image fragment S_1.

Here, image fragment S_0 and image fragment S_1 are three-dimensional matrices of the same size (shape), and S_0+S_1=D.

Step S1105: Node 1 loads image fragment S_0.

Step S1106: Node 1 uses a locally deployed feature extraction operator and a feature extraction operator deployed in node 2 to extract features from the image fragment S_0.

Node 1 performs interactive calculations with node 2, to realize the joint feature extraction from image fragment S_0 by the locally deployed feature extraction operator and the feature extraction operator deployed in node 2.

Step S1107: Node 1 outputs feature vector shard FS_0.

Step S1108: Node 2 loads image fragment S_1.

Step S1109: Node 2 uses a locally deployed feature extraction operator and a feature extraction operator deployed in node 1 to extract features from image fragment S_1.

Step S1110: Node 2 outputs feature vector shard FS_1.

Step S1111: The terminal device reports an error message indicating that there is no facial information.

In the embodiments of the disclosure, the biometric feature extraction model is fragmented to obtain a plurality of feature extraction model fragments, and the plurality of feature extraction model fragments are respectively deployed in different nodes, thereby ensuring that the model parameters are not leaked. When extracting features from the target biometric information, the target biometric information is first fragmented to obtain a plurality of biometric information fragments, and then the plurality of biometric information fragments are distributed to different nodes. Each node extracts features from a biometric information fragment based on the locally deployed feature extraction model fragment and a feature extraction model fragment deployed by other nodes to obtain a biometric feature vector shard, so that each node needs to be combined with another node(s) to extract biometric features, and each node obtains just part of the biometric feature vector, avoiding the problem that the entire biometric feature vector is calculated by a single device and stored in a single environment, thereby improving the security of biometric feature extraction. In addition, the embodiments of the disclosure provide a general computing solution that may be applied to many types of feature extraction models and scenarios, and has strong versatility.

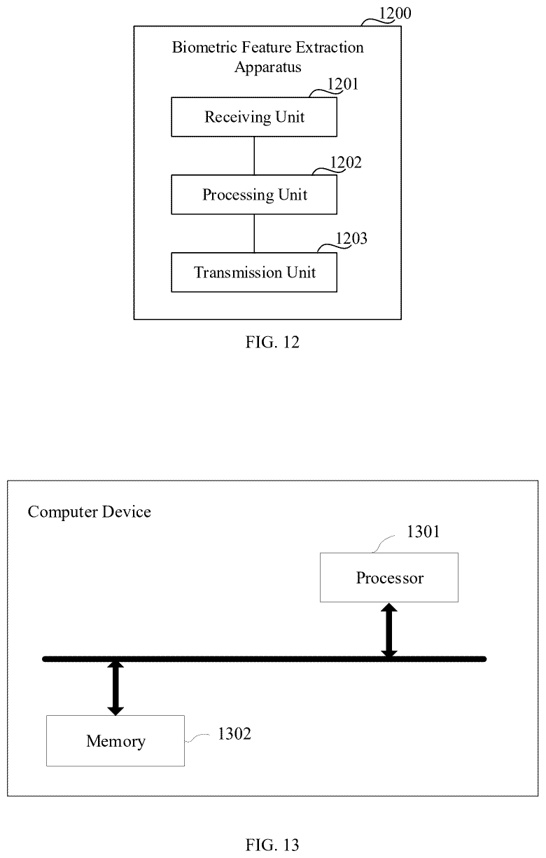

Based on similar technical concepts, the embodiments of the disclosure provide a schematic structural diagram of a biometric feature extraction apparatus, which is applied to a node in a multi-party secure computing system. As shown in FIG. 12, the apparatus 1200 includes the following.

A receiving unit 1201, configured to receive a biometric information fragment sent by a terminal device, where the biometric information fragment is obtained after performing fragmentation processing on obtained target biometric information by the terminal device.

A processing unit 1202, configured to perform joint feature extraction processing on the biometric information fragment through a locally deployed first feature extraction model fragment and a second feature extraction model fragment deployed in at least one other node, to obtain a corresponding biometric feature vector shard, where the first feature extraction model fragment and at least one second feature extraction model fragment are obtained by performing fragmentation processing on a biometric feature extraction model.

In some embodiments, the first feature extraction model fragment includes a first convolution module, a first activation module, a first pooling module and a first fully connected module.

The processing unit 1202 is specifically configured to: obtain, through the first convolution module, a first convolutional feature fragment corresponding to the biometric information fragment; combine the first activation module, the first pooling module, and a second activation module and a second pooling module in the at least one second feature extraction model fragment to perform activation processing and pooling processing on the first convolutional feature fragment to obtain a first pooling processing result; and performing fragmentation processing on the first pooling processing result to obtain a plurality of pooled feature fragments; and process, through the first fully connected module, a first pooled feature fragment to obtain the biometric feature vector shard, where the first pooled feature fragment is determined based on undistributed pooled feature fragments among the plurality of pooled feature fragments and received pooled feature fragments distributed by other nodes.

In some embodiments, the apparatus 1200 further includes a transmission unit 1203, and the first feature extraction model fragment further includes a first interaction module; and the transmission unit 1203 is specifically configured to: after performing fragmentation processing on the first pooling processing result to obtain the plurality of pooled feature fragments, distribute, through the first interaction module, at least one pooled feature fragment among the plurality of pooled feature fragments to the at least one other node accordingly.

In some embodiments, the first feature extraction model fragment further includes a first random mask module; and the processing unit 1202 is specifically configured to: perform, through the first random mask model, mask recovery processing on the first convolutional feature fragment based on a second convolutional feature fragment input into at least one second activation module, to obtain a first convolutional feature recovery result; perform, through the first activation module, activation processing on the first convolutional feature recovery result to obtain a first activation processing result, and performing fragmentation processing on the first activation processing result to obtain a plurality of activated feature fragments; perform, through the first random mask module, mask recovery processing on a first activated feature fragment based on a second activated feature fragment input into at least one second pooling module, to obtain a first activated feature recovery result, where the first activated feature fragment is determined based on undistributed activated feature fragments among the plurality of activated feature fragments and activated feature fragments distributed by the other nodes; and perform, through the first pooling module, pooling processing on the first activated feature recovery result to obtain the first pooling processing result.

In some embodiments, the apparatus 1200 further includes a transmission unit 1203, the first feature extraction model fragment further includes a first interaction module; and the transmission unit 1203 is specifically configured to: after performing fragmentation processing on the first activation processing result to obtain the plurality of activated feature fragments, distribute, through the first interaction module, at least one activated feature fragment, among the plurality of activated feature fragments, to the at least one other node accordingly.

In some embodiments, the processing unit 1202 is specifically configured to: obtain, through the first interaction module, partial feature values in each second convolutional feature fragment; and perform, through the first random mask module, mask recovery processing on the first convolutional feature fragment based on the obtained partial feature values to obtain the first convolutional feature recovery result, where the first convolutional feature recovery result is complementary to a second convolutional feature recovery result obtained by the at least one second feature extraction model fragment.

In some embodiments, the processing unit 1202 is specifically configured to: obtain, through the first interaction module, partial feature values in each second activated feature fragment; and perform mask recovery processing on the first activated feature fragment based on the obtained partial feature values to obtain the first activated feature recovery result, where the first activated feature recovery result is complementary to a second activated feature recovery result obtained by the at least one second feature extraction model fragment.

In some embodiments, the second feature extraction model fragment includes a second convolution module; and the processing unit 1202 is specifically configured to: perform joint convolution processing on the biometric information fragment through a fragmented convolution kernel in the first convolution module and a fragmented convolution kernel in at least one second convolution module, to obtain the first convolutional feature fragment.

In some embodiments, the second feature extraction model fragment includes a second convolution module; and the processing unit 1202 is specifically configured to: perform convolution processing on the biometric information fragment through a plaintext convolution kernel in the first convolution module to obtain the first convolutional feature fragment, where the plaintext convolution kernel in the first convolution module is the same as a plaintext convolution kernel in a second convolution module.

In the embodiments of the disclosure, the biometric feature extraction model is fragmented to obtain a plurality of feature extraction model fragments, and the plurality of feature extraction model fragments are respectively deployed in different nodes, thereby ensuring that the model parameters are not leaked. When extracting features from the target biometric information, the target biometric information is first fragmented to obtain a plurality of biometric information fragments, and then the plurality of biometric information fragments are distributed to different nodes. Each node extracts features from a biometric information fragment based on the locally deployed feature extraction model fragment and a feature extraction model fragment deployed by another node to obtain a biometric feature vector shard, so that each node needs to be combined with the other node(s) to extract biometric features, and each node obtains just part of the biometric feature vector, avoiding the problem that the entire biometric feature vector is calculated by a single device and stored in a single environment, thereby improving the security of biometric feature extraction. In addition, the embodiments of the disclosure provide a general computing solution that may be applied to many types of feature extraction models and scenarios, and has strong versatility.

Based on similar technical concepts, the embodiments of the disclosure provide a computer device, which may be a node shown in FIG. 1. As shown in FIG. 13, the computer device includes at least one processor 1301, and a memory 1302 coupled to the at least one processor. The embodiments of the disclosure do not limit the specific connection medium between the processor 1301 and the memory 1302, and FIG. 13 takes the example of the processor 1301 and the memory 1302 being connected via a bus. The bus may be divided into an address bus, a data bus, a control bus, and the like.

In the embodiments of the disclosure, the memory 1302 stores instructions that may be executed by at least one processor 1301, and the at least one processor 1301 may perform the steps of the above-described biometric feature extraction methods by executing the instructions stored in the memory 1302.

Here, the processor 1301 is the control center of the computer device, and may use various interfaces and lines to connect various parts of the computer device, and realize biometric extraction by running or executing instructions stored in the memory 1302 and calling data stored in the memory 1302. In some embodiments, the processor 1301 may include one or more processing units, and the processor 1301 may integrate an application processor and a modem processor, where the application processor mainly processes the operating system, user interface, and application programs, and the modem processor mainly processes wireless communications. It is to be noted that the above-described modem processor may not be integrated into the processor 1301. In some embodiments, the processor 1301 and the memory 1302 may be implemented on the same chip, and in some embodiments, the processor 1301 and the memory 1302 may also be implemented separately on individual chips.

The processor 1301 may be a general-purpose processor, such as a central processing unit (CPU), a digital signal processor, an application-specific integrated circuit (ASIC), a field programmable gate array or other programmable logic devices, a discrete gate or transistor logic device, or a discrete hardware component, and may implement or execute the methods, steps, and logic block diagrams disclosed in the embodiments of the disclosure. A general-purpose processor may be a microprocessor or any conventional processor, etc. The steps of the method disclosed in the embodiments of the disclosure may be directly embodied as being executed by a hardware processor, or may be executed by a combination of hardware and software modules in the processor.

The memory 1302 is a non-transitory computer-readable storage medium that may be used to store non-volatile software programs, non-volatile computer executable programs, and modules. The memory 1302 may include at least one type of storage medium, such as a flash memory, a hard disk, a multimedia card, a card-type memory, a random access memory (RAM), a static random access memory (SRAM), a programmable read-only memory (PROM), a read-only memory (ROM), an electrically erasable programmable read-only memory (EEPROM), a magnetic memory, a disk, an optical disk, and the like. The memory 1302 can be any other medium that may be used to carry or store the desired program code in the form of an instruction or data structure and may be accessed by a computer device, but is not limited thereto. The memory 1302 in the embodiments of the disclosure may also be a circuit or any other device that may realize a storage function, and is used to store program instructions and/or data.

Based on similar inventive concepts, embodiments of the disclosure provide a computer-readable storage medium, which stores a computer program that may be executed by a computer device. When the program runs on the computer device, the computer device executes the steps of the above-described biometric feature extraction methods.

Based on similar inventive concepts, embodiments of the disclosure provide a computer program product, which includes a computer program stored on a computer-readable storage medium, and the computer program includes program instructions. When the program instructions are executed by a computer device, the computer device executes the steps of the above-described biometric extraction methods.

It should be understood by those skilled in the art that the embodiments of the disclosure may be provided as methods or computer program products. Therefore, the disclosure may take the form of a complete hardware embodiment, a complete software embodiment, or an embodiment combining software and hardware aspects. Moreover, the disclosure may take the form of a computer program product implemented on one or more computer-usable storage media (including but not limited to disk storage, CD-ROM, optical storage, etc.) containing computer-usable program code.

The disclosure is described with reference to the flowcharts and/or block diagrams of the methods, devices (systems), and computer program products according to the embodiments of the disclosure. It should be understood that each process and/or block in the flowcharts and/or block diagrams, as well as the combination of the processes and/or blocks in the flowcharts and/or block diagrams, may be implemented by computer program instructions. These computer program instructions may be provided to a processor of a general-purpose computer, a special-purpose computer, an embedded processor, or other programmable data processing devices to produce a machine, so that the instructions executed by the processor of the computer device or other programmable data processing devices produce a device for implementing the functions specified in one or more processes in the flowcharts and/or one or more blocks in the block diagrams.

These computer program instructions may also be stored in a computer-readable memory that may direct a computer device or other programmable data processing devices to operate in a specific manner, so that the instructions stored in the computer-readable memory produce a manufactured product including an instruction device that implements the functions specified in one or more processes in the flowcharts and/or one or more blocks in the block diagrams.

These computer program instructions may also be loaded onto a computer device or other programmable data processing devices so that a series of operating steps are executed on the computer device or other programmable devices to produce a process implemented by the computer device, thereby the instructions executed on the computer device or other programmable devices provide steps for implementing the functions specified in one or more processes in the flowcharts and/or one or more blocks in the block diagrams.

Although the specific embodiments of the disclosure have been described, those skilled in the art may make additional changes and modifications to these embodiments once they have learned the basic creative concepts. Therefore, the appended claims are intended to be interpreted as including these embodiments and all changes and modifications that fall within the scope of the disclosure.

Obviously, those skilled in the art may make various changes and modifications to the disclosure without departing from the spirit and scope of the disclosure. Thus, if these modifications and variations of the disclosure fall within the scope of the claims of the disclosure and their equivalents, the disclosure is also intended to include these modifications and variations.

1. A biometric feature extraction method, applied to a node in a multi-party secure computing system, comprising:
receiving a biometric information fragment sent by a terminal device, wherein the biometric information fragment is obtained after performing fragmentation processing on obtained target biometric information by the terminal device; and
performing joint feature extraction processing on the biometric information fragment through a locally deployed first feature extraction model fragment and a second feature extraction model fragment deployed in at least one other node, to obtain a corresponding biometric feature vector shard, wherein the first feature extraction model fragment and at least one second feature extraction model fragment are obtained by performing fragmentation processing on a biometric feature extraction model.

2. The method according to claim 1, wherein:
the first feature extraction model fragment includes a first convolution module, a first activation module, a first pooling module and a first fully connected module; and
performing joint feature extraction processing on the biometric information fragment through the locally deployed first feature extraction model fragment and the second feature extraction model fragment deployed in the at least one other node to obtain the corresponding biometric feature vector shard includes:
obtaining, through the first convolution module, a first convolutional feature fragment corresponding to the biometric information fragment,
combining the first activation module, the first pooling module, and a second activation module and a second pooling module in the at least one second feature extraction model fragment to perform activation processing and pooling processing on the first convolutional feature fragment to obtain a first pooling processing result; and performing fragmentation processing on the first pooling processing result to obtain a plurality of pooled feature fragments, and
processing, through the first fully connected module, a first pooled feature fragment to obtain the biometric feature vector shard, wherein the first pooled feature fragment is determined based on undistributed pooled feature fragments among the plurality of pooled feature fragments and received pooled feature fragments distributed by other nodes.

3. The method according to claim 2, wherein:
the first feature extraction model fragment further includes a first interaction module; and
after performing fragmentation processing on the first pooling processing result to obtain the plurality of pooled feature fragments, the method further includes:
distributing, through the first interaction module, at least one pooled feature fragment among the plurality of pooled feature fragments to the at least one other node accordingly.

4. The method according to claim 2, wherein:
the first feature extraction model fragment further includes a first random mask module; and
combining the first activation module, the first pooling module, and the second activation module and the second pooling module in the at least one second feature extraction model fragment to perform activation processing and pooling processing on the first convolutional feature fragment to obtain the first pooling processing result includes:
performing, through the first random mask model, mask recovery processing on the first convolutional feature fragment based on a second convolutional feature fragment input into at least one second activation module, to obtain a first convolutional feature recovery result,
performing, through the first activation module, activation processing on the first convolutional feature recovery result to obtain a first activation processing result, and performing fragmentation processing on the first activation processing result to obtain a plurality of activated feature fragments,
performing, through the first random mask module, mask recovery processing on a first activated feature fragment based on a second activated feature fragment input into at least one second pooling module, to obtain a first activated feature recovery result, wherein the first activated feature fragment is determined based on undistributed activated feature fragments among the plurality of activated feature fragments and activated feature fragments distributed by the other nodes, and
performing, through the first pooling module, pooling processing on the first activated feature recovery result to obtain the first pooling processing result.

5. The method according to claim 4, wherein:
the first feature extraction model fragment further includes a first interaction module; and
after performing fragmentation processing on the first activation processing result to obtain the plurality of activated feature fragments, the method further includes:
distributing, through the first interaction module, at least one activated feature fragment, among the plurality of activated feature fragments, to the at least one other node accordingly.

6. The method according to claim 5, wherein performing, through the first random mask module, mask recovery processing on the first convolutional feature fragment based on the second convolutional feature fragment input into the at least one second pooling module, to obtain the first convolutional feature recovery result comprises:
obtaining, through the first interaction module, partial feature values in each second convolutional feature fragment; and
performing, through the first random mask module, mask recovery processing on the first convolutional feature fragment based on the obtained partial feature values to obtain the first convolutional feature recovery result, wherein the first convolutional feature recovery result is complementary to a second convolutional feature recovery result obtained by the at least one second feature extraction model fragment.

7. The method according to claim 5, wherein performing, through the first random mask module, mask recovery processing on the first activated feature fragment among the plurality of activated feature fragments based on the second activated feature fragment input into the at least one second pooling module, to obtain the first activated feature recovery result comprises:
obtaining, through the first interaction module, partial feature values in each second activated feature fragment; and
performing mask recovery processing on the first activated feature fragment based on the obtained partial feature values to obtain the first activated feature recovery result, wherein the first activated feature recovery result is complementary to a second activated feature recovery result obtained by the at least one second feature extraction model fragment.

8. The method according to claim 2, wherein:
the second feature extraction model fragment includes a second convolution module; and
obtaining, through the first convolution module, the first convolutional feature fragment corresponding to the biometric information fragment includes:
performing joint convolution processing on the biometric information fragment through a fragmented convolution kernel in the first convolution module and a fragmented convolution kernel in at least one second convolution module, to obtain the first convolutional feature fragment.

9. The method according to claim 2, wherein:
the second feature extraction model fragment includes a second convolution module; and
obtaining, through the first convolution module, the first convolutional feature fragment corresponding to the biometric information fragment includes:
performing convolution processing on the biometric information fragment through a plaintext convolution kernel in the first convolution module to obtain the first convolutional feature fragment, wherein the plaintext convolution kernel in the first convolution module is the same as a plaintext convolution kernel in a second convolution module.

10. (canceled)

11. A computer device, comprising a memory, a processor and a computer program stored in the memory and executable on the processor, wherein the processor, when executing the program, is caused to implement:
receiving a biometric information fragment sent by a terminal device, wherein the biometric information fragment is obtained after performing fragmentation processing on obtained target biometric information by the terminal device; and
performing joint feature extraction processing on the biometric information fragment through a locally deployed first feature extraction model fragment and a second feature extraction model fragment deployed in at least one other node, to obtain a corresponding biometric feature vector shard, wherein the first feature extraction model fragment and at least one second feature extraction model fragment are obtained by performing fragmentation processing on a biometric feature extraction model.

12. A non-transitory computer-readable storage medium, storing a computer program executable by a computer device, and when the program is run on the computer device, the computer program causes at least one processor to implement a biometric information extraction method comprising:
receiving a biometric information fragment sent by a terminal device, wherein the biometric information fragment is obtained after performing fragmentation processing on obtained target biometric information by the terminal device; and
performing joint feature extraction processing on the biometric information fragment through a locally deployed first feature extraction model fragment and a second feature extraction model fragment deployed in at least one other node, to obtain a corresponding biometric feature vector shard, wherein the first feature extraction model fragment and at least one second feature extraction model fragment are obtained by performing fragmentation processing on a biometric feature extraction model.

13. The computer device according to claim 11, wherein the first feature extraction model fragment includes a first convolution module, a first activation module, a first pooling module and a first fully connected module, and the processor is further caused to implement:
obtaining, through the first convolution module, a first convolutional feature fragment corresponding to the biometric information fragment;
combining the first activation module, the first pooling module, and a second activation module and a second pooling module in the at least one second feature extraction model fragment to perform activation processing and pooling processing on the first convolutional feature fragment to obtain a first pooling processing result; and performing fragmentation processing on the first pooling processing result to obtain a plurality of pooled feature fragments; and
processing, through the first fully connected module, a first pooled feature fragment to obtain the biometric feature vector shard, wherein the first pooled feature fragment is determined based on undistributed pooled feature fragments among the plurality of pooled feature fragments and received pooled feature fragments distributed by other nodes.

14. The computer device according to claim 13, wherein the first feature extraction model fragment further includes a first interaction module, and the processor is further caused to implement:
after performing fragmentation processing on the first pooling processing result to obtain the plurality of pooled feature fragments, distributing, through the first interaction module, at least one pooled feature fragment among the plurality of pooled feature fragments to the at least one other node accordingly.

15. The computer device according to claim 13, wherein the first feature extraction model fragment further includes a first random mask module, and the processor is further caused to implement:
performing, through the first random mask model, mask recovery processing on the first convolutional feature fragment based on a second convolutional feature fragment input into at least one second activation module, to obtain a first convolutional feature recovery result;
performing, through the first activation module, activation processing on the first convolutional feature recovery result to obtain a first activation processing result, and performing fragmentation processing on the first activation processing result to obtain a plurality of activated feature fragments;
performing, through the first random mask module, mask recovery processing on a first activated feature fragment based on a second activated feature fragment input into at least one second pooling module, to obtain a first activated feature recovery result, wherein the first activated feature fragment is determined based on undistributed activated feature fragments among the plurality of activated feature fragments and activated feature fragments distributed by the other nodes; and
performing, through the first pooling module, pooling processing on the first activated feature recovery result to obtain the first pooling processing result.

16. The computer device according to claim 15, wherein the first feature extraction model fragment further includes a first interaction module, and the processor is further caused to implement:
after performing fragmentation processing on the first activation processing result to obtain the plurality of activated feature fragments, distributing, through the first interaction module, at least one activated feature fragment, among the plurality of activated feature fragments, to the at least one other node accordingly.

17. The computer device according to claim 16, wherein the processor is further caused to implement:
obtaining, through the first interaction module, partial feature values in each second convolutional feature fragment; and
performing, through the first random mask module, mask recovery processing on the first convolutional feature fragment based on the obtained partial feature values to obtain the first convolutional feature recovery result, wherein the first convolutional feature recovery result is complementary to a second convolutional feature recovery result obtained by the at least one second feature extraction model fragment.

18. The computer device according to claim 16, wherein the processor is further caused to implement:
obtaining, through the first interaction module, partial feature values in each second activated feature fragment; and
performing mask recovery processing on the first activated feature fragment based on the obtained partial feature values to obtain the first activated feature recovery result, wherein the first activated feature recovery result is complementary to a second activated feature recovery result obtained by the at least one second feature extraction model fragment.

19. The computer device according to claim 13, wherein the second feature extraction model fragment includes a second convolution module, and the processor is further caused to implement:
performing joint convolution processing on the biometric information fragment through a fragmented convolution kernel in the first convolution module and a fragmented convolution kernel in at least one second convolution module, to obtain the first convolutional feature fragment.

20. The computer device according to claim 13, wherein the second feature extraction model fragment includes a second convolution module, and the processor is further caused to implement:
performing convolution processing on the biometric information fragment through a plaintext convolution kernel in the first convolution module to obtain the first convolutional feature fragment, wherein the plaintext convolution kernel in the first convolution module is the same as a plaintext convolution kernel in a second convolution module.

21. The non-transitory computer-readable storage medium according to claim 12, wherein the first feature extraction model fragment includes a first convolution module, a first activation module, a first pooling module and a first fully connected module, and the computer program further causes the at least one processor to implement:
obtaining, through the first convolution module, a first convolutional feature fragment corresponding to the biometric information fragment;
combining the first activation module, the first pooling module, and a second activation module and a second pooling module in the at least one second feature extraction model fragment to perform activation processing and pooling processing on the first convolutional feature fragment to obtain a first pooling processing result; and performing fragmentation processing on the first pooling processing result to obtain a plurality of pooled feature fragments; and
processing, through the first fully connected module, a first pooled feature fragment to obtain the biometric feature vector shard, wherein the first pooled feature fragment is determined based on undistributed pooled feature fragments among the plurality of pooled feature fragments and received pooled feature fragments distributed by other nodes.
